(19) United States
(12) Patent Application Publication
(10) Pub. No.: US 2025/0065305 A1
(43) Pub. Date: Feb. 27, 2025

(54) METHOD OF MANUFACTURING CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 18/785,461

(22) Filed: Jul. 26, 2024

(30) Foreign Application Priority Data
Aug. 22, 2023 (JP) 2023-134618

(51) Int. Cl. B01J 20/30; B01D 53/04; B01J 20/20; B01J 20/28

(52) U.S. Cl. CPC B01J 20/3007; B01D 53/04; B01J 20/20; B01J 20/28023; B01J 20/3035; B01D 2257/708; B01D 2258/01

(57) ABSTRACT

A canister includes an activated carbon molding configured to adsorb an evaporated fuel originating in a fuel tank of a vehicle; and an adsorption chamber accommodating the activated carbon molding. A method of manufacturing the canister includes pressing fibrous activated carbons in a specific direction, or performing suction to thereby gather the fibrous activated carbons in the specific direction and mold the fibrous activated carbons into the activated carbon molding that has a columnar shape; and arranging, inside the adsorption chamber, the activated carbon molding produced such that a pressing direction or a suction direction for the activated carbon molding is perpendicular to a flow direction of the evaporated fuel.

### CROSS-REFERENCE TO RELATED APPLICATIONS

The present application claims the benefit of Japanese Patent Application No. 2023-134618 filed on Aug. 22, 2023 with the Japan Patent Office, the disclosure of which is incorporated herein in its entirety by reference.

### BACKGROUND

The present disclosure relates to a method of manufacturing a canister.

International Patent Application Publication No. 2023/054088 (hereinafter, “WO 2023/054088A1”) discloses a canister including an activated carbon molding and an adsorption chamber. The activated carbon molding is accommodated in the adsorption chamber. The activated carbon molding is configured to adsorb an evaporated fuel originating in a fuel tank of a vehicle.

### SUMMARY

As disclosed in WO 2023/054088A1, it is desirable that a canister exhibits low pressure loss. In one aspect of the present disclosure, it is desirable to provide a technique to reduce pressure loss in a canister.

One aspect of the present disclosure provides a method of manufacturing a canister including an activated carbon molding and an adsorption chamber. The activated carbon molding is configured to adsorb an evaporated fuel originating in a fuel tank of a vehicle. The adsorption chamber accommodates the activated carbon molding. The method of manufacturing a canister comprises: (i) pressing fibrous activated carbons in a specific direction, or performing suction to thereby gather the fibrous activated carbons in the specific direction and mold the fibrous activated carbons into the activated carbon molding that has a columnar shape; and (ii) arranging, inside the adsorption chamber, the activated carbon molding produced such that a pressing direction or a suction direction in the activated carbon molding is perpendicular to a flow direction of the evaporated fuel. Such a configuration can reduce pressure loss in the canister.

In one aspect of the present disclosure, the activated carbon molding may be produced by filling a dispersion liquid containing the fibrous activated carbons dispersed therein into a molding die whose bottom wall is provided with two or more through holes, and gathering the fibrous activated carbons towards the bottom wall due to the suction. Such a configuration enables a relatively simple apparatus to achieve a canister exhibiting reduced pressure loss.

In one aspect of the present disclosure, in a cross-section perpendicular to the flow direction of the evaporated fuel, the activated carbon molding arranged inside the adsorption chamber may have an equivalent diameter greater than a length of the activated carbon molding along the flow direction of the evaporated fuel. Such a configuration can achieve a canister including the activated carbon molding that has the equivalent diameter, in the cross-section perpendicular to the flow direction of the evaporated fuel, greater than the length of the activated carbon molding along the flow direction of the evaporated fuel, and exhibits the reduced pressure loss.

In one aspect of the present disclosure, an outer circumferential surface, about the flow direction of the evaporated fuel, of the activated carbon molding arranged inside the adsorption chamber may contact an inner surface of the adsorption chamber.

In one aspect of the present disclosure, the adsorption chamber may be connected to an atmosphere port open to atmosphere.

### BRIEF DESCRIPTION OF THE DRAWINGS

Example embodiments of the present disclosure will be described hereinafter with reference to the accompanying drawings, in which:

FIG. 1 is a cross-sectional view of a canister according to a first embodiment;

FIG. 2A is a schematic view illustrating a molding process according to the first embodiment;

FIG. 2B is a schematic view illustrating a state subsequent to the molding process in FIG. 2A according to the first embodiment;

FIG. 2C is a schematic view illustrating a third adsorbent molded in the molding process according to the first embodiment;

FIG. 3 is a cross-sectional view illustrating an arrangement process according to the first embodiment;

FIG. 4A is a schematic view illustrating a molding process according to a second embodiment;

FIG. 4B is a schematic view illustrating a state subsequent to the molding process in FIG. 4A according to the second embodiment;

FIG. 4C is a schematic view illustrating a third adsorbent molded in the molding process according to the second embodiment;

FIG. 5A is a schematic view illustrating a molding work in a molding process according to a third embodiment;

FIG. 5B is a schematic view illustrating a cutting work in the molding process according to the third embodiment; and

FIG. 5C is a schematic view illustrating a third adsorbent molded in the molding process according to the third embodiment.

### DETAILED DESCRIPTION OF EXEMPLARY EMBODIMENTS

### 1. First Embodiment

### 1-1. Configuration of Canister

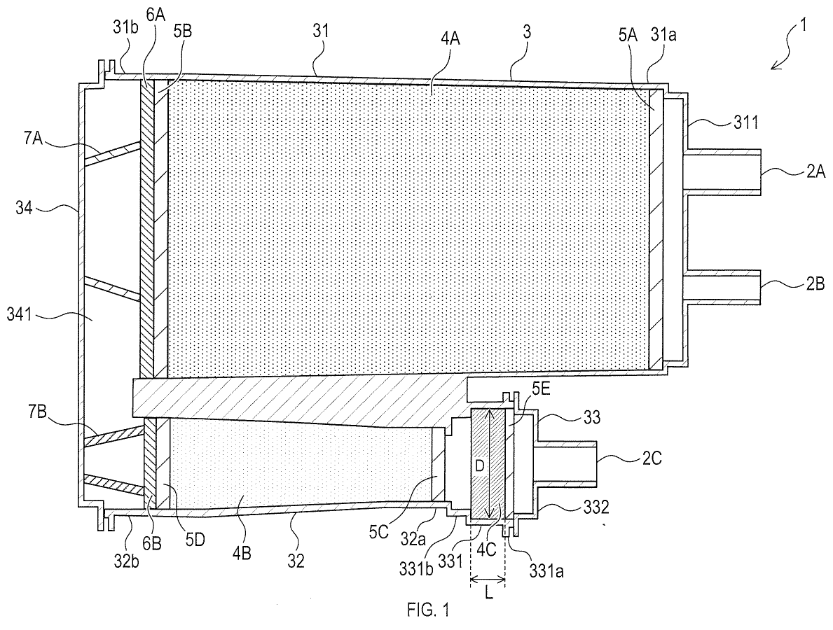

A canister 1 illustrated in FIG. 1 is an evaporated fuel treatment device configured to adsorb and desorb an evaporated fuel originating in a fuel tank of a vehicle. The canister 1 comprises a charge port 2A, a purge port 2B, an atmosphere port 2C, a case 3, a first adsorbent 4A, a second adsorbent 4B, a third adsorbent 4C, a first filter 5A, a second filter 5B, a third filter 5C, a fourth filter 5D, a fifth filter 5E, a first grid 6A, a second grid 6B, a first spring 7A, and a second spring 7B.

The charge port 2A is coupled to the fuel tank of the vehicle via a pipe. The charge port 2A is configured to take the evaporated fuel originating in the fuel tank into the canister 1.

The purge port 2B is coupled to an intake pipe of an engine of the vehicle via a purge valve. The purge port 2B is configured to discharge the evaporated fuel from the canister 1 and supply the discharged evaporated fuel to the engine.

The atmosphere port 2C is open to the atmosphere via a pipe. The atmosphere port 2C is configured to release a gas removed of the evaporated fuel to the atmosphere. The atmosphere port 2C is configured to take in external air (that is, purge air) to thereby desorb (that is, purge) the evaporated fuel adsorbed by the canister 1.

The case 3 is a housing that includes a space therein. The case 3 is provided with the charge port 2A, the purge port 2B, and the atmosphere port 2C. The case 3 includes a first adsorption chamber 31, a second adsorption chamber 32, a third adsorption chamber 33, and a communicating part 34.

The first adsorption chamber 31 is a part that accommodates the first adsorbent 4A. The first adsorption chamber 31 has a bottomed cylindrical shape. Hereinafter, an end of the first adsorption chamber 31 adjacent to a bottom wall 311 in an axial direction is referred to as “first end 31a” of the first adsorption chamber 31; and an end of the first adsorption chamber 31 on an opposite side to the first end 31a in the axial direction is referred to as “second end 31b” of the first adsorption chamber 31. The bottom wall 311 is provided with the charge port 2A and the purge port 2B. That is, the first adsorption chamber 31 is connected to the charge port 2A and the purge port 2B. That the charge port 2A and the purge port 2B are connected to the first adsorption chamber 31 means, in further detail, that the charge port 2A and the purge port 2B are connected without interposing another chamber (that is, directly connected) to the first adsorption chamber 31.

The first adsorption chamber 31 communicates with the second adsorption chamber 32 via the communicating part 34 at the second end 31b thereof. In the first adsorption chamber 31, flow directions of the evaporated fuel are parallel to the axial direction of the first adsorption chamber 31. There are arranged the first adsorbent 4A, the first filter 5A, the second filter 5B, and the first grid 6A inside the first adsorption chamber 31.

The first adsorbent 4A is configured to adsorb the evaporated fuel. The first adsorbent 4A is, for example, an aggregate of granular activated carbon.

The first filter 5A and the second filter 5B are formed so as not to allow the first adsorbent 4A to pass therethrough, but on the other hand, to allow the gas to pass therethrough. In the first adsorption chamber 31, the first filter 5A and the second filter 5B are arranged so as to interpose the first adsorbent 4A in the flow directions of the evaporated fuel. The first filter 5A is closer to the first end 31a of the first adsorption chamber 3 with respect to the first adsorbent 4A. The second filter 5B is closer to the second end 31b of the first adsorption chamber 31 with respect to the first adsorbent 4A.

The first grid 6A is a plate-like member provided with a vent. The first grid 6A is in the form of a lattice, for example. The first grid 6A is closer to the second end 31b of the first adsorption chamber 31 with respect to (that is, opposite to the first adsorbent 4A across) the second filter 5B.

In the first adsorption chamber 31, the first adsorbent 4A is pressed towards the charge port 2A and the purge port 2B with the first spring 7A via the second filter 5B and the first grid 6A. The first spring 7A is an elastic member configured to bias a target object in a specific direction.

The second adsorption chamber 32 is a part that accommodates the second adsorbent 4B. The second adsorption chamber 32 has a cylindrical shape. Hereinafter, both ends of the second adsorption chamber 32 in an axial direction are referred to as “first end 32a” and “second end 32b” of the second adsorption chamber 32. The second adsorption chamber 32 is arranged in an aligned manner with the first adsorption chamber 31 in a radial direction. The second adsorption chamber 32 is arranged such that the second end 32b thereof faces the same side toward which the second end 31b of the first adsorption chamber 31 faces.

The second adsorption chamber 32 communicates with the first adsorption chamber 31 via the communicating part 34 at the second end 32b thereof. The second adsorption chamber 32 communicates with the third adsorption chamber 33 at the first end 32a thereof. In the second adsorption chamber 32, flow directions of the evaporated fuel are parallel to the axial direction of the second adsorption chamber 32. There are arranged the second adsorbent 4B, the third filter 5C, the fourth filter 5D, and the second grid 6B inside the second adsorption chamber 32.

The second adsorbent 4B is configured to adsorb the evaporated fuel. The second adsorbent 4B is, for example, an aggregate of granular activated carbon.

The third filter 5C and the fourth filter 5D are formed so as not to allow the second adsorbent 4B to pass therethrough, but on the other hand, to allow the gas to pass therethrough. In the second adsorption chamber 32, the third filter 5C and the fourth filter 5D are arranged so as to interpose the second adsorbent 4B in the flow directions of the evaporated fuel. The third filter 5C is closer to the first end 32a of the second adsorption chamber 32 with respect to the second adsorbent 4B. The fourth filter 5D is closer to the second end 32b of the second adsorption chamber 32 with respect to the second adsorbent 4B.

The second grid 6B is a plate-like member provided with a vent. The second grid 6B is in the form of a lattice, for example. The second grid 6B is closer to the second end 32b of the second adsorption chamber 32 with respect to (that is, opposite to the second adsorbent 4B across) the fourth filter 5D.

In the second adsorption chamber 32, the second adsorbent 4B is pressed towards the third adsorption chamber 33 (that is, towards the atmosphere port 2C as described below) with the second spring 7B via the fourth filter 5D and the second grid 6B. The second spring 7B is an elastic member configured to bias a target object in a specific direction.

The third adsorption chamber 33 is a part that accommodates the third adsorbent 4C. The third adsorption chamber 33 includes a cylindrical part 331 and a lid 332. The cylindrical part 331 is a part having a cylindrical shape, such as a square cylindrical shape. Hereinafter, both ends of the cylindrical part 331 in an axial direction are referred to as “first end 331a” and “second end 331b” of the cylindrical part 331. The lid 332 is arranged so as to cover an opening of the cylindrical part 331 at the first end 331a. The lid 332 is joined to the cylindrical part 331 employing vibration welding, for example. The lid 332 is provided with the atmosphere port 2C. That is, the atmosphere port 2C is connected to the third adsorption chamber 33. That the atmosphere port 2C is connected to the third adsorption chamber 33 means, in further detail, that the atmosphere port 2C is connected without interposing another chamber (that is, directly connected) to the third adsorption chamber 33.

The third adsorption chamber 33 is arranged in an aligned manner with the first adsorption chamber 31 in the radial direction. The third adsorption chamber 33 is arranged such that the first end 331a of the cylindrical part 331 faces the same side to which the first end 31a of the first adsorption chamber 31 faces. The third adsorption chamber 33 is arranged in an aligned manner with the second adsorption chamber 32 in the axial direction. The axial direction of the third adsorption chamber 33 is consistent with the axial direction of the cylindrical part 331.

The third adsorption chamber 33 communicates with the second adsorption chamber 32 at the second end 331b of the cylindrical part 331. In the third adsorption chamber 33, flow directions of the evaporated fuel are parallel to the axial direction of the third adsorption chamber 33. There are arranged the third adsorbent 4C and the fifth filter 5E inside the third adsorption chamber 33.

The third adsorbent 4C is configured to adsorb the evaporated fuel. The third adsorbent 4C is an activated carbon molding produced by molding fibrous activated carbons. The third adsorbent 4C is integrally molded. In other words, the third adsorbent 4C is not a combination of two or more activated carbon moldings, but rather a single activated carbon molding.

The third adsorbent 4C has a columnar shape. The third adsorbent 4C is, for example, in the form of a quadrangular prism. The third adsorbent 4C is arranged inside the third adsorption chamber 33 such that an axial direction of the third adsorbent 4C is consistent with the axial direction of the third adsorption chamber 33. An outer circumferential surface of the third adsorbent 4C contacts an inner surface of the third adsorption chamber 33. The outer circumferential surface of the third adsorbent 4C means a circumferential part in an outer surface of the third adsorbent 4C about the axial direction of the third adsorbent 4C, in other words, about flow directions of the evaporated fuel. The directions of the evaporated fuel mentioned herein are, more specifically, the flow directions of the evaporated fuel in the third adsorption chamber 33.

In a cross-section perpendicular to the flow directions of the evaporated fuel, the third adsorbent 4C has an equivalent diameter D greater than a length L thereof along the flow directions of the evaporated fuel. The equivalent diameter D in the cross-section perpendicular to the flow directions of the evaporated fuel means a value obtained by averaging, in the flow directions of the evaporated fuel, diameters (D=(S/π)^{1/2}×2) of a circle having the same area S as that of the cross-section perpendicular to the flow directions of the evaporated fuel.

The fifth filter 5E is configured not to allow the third adsorbent 4C to pass therethrough, but on the other hand, to allow the gas to pass therethrough. The fifth filter 5E is closer to the first end 331a of the cylindrical part 331 with respect to the third adsorbent 4C.

The communicating part 34 is a part forming a communicating path 341 that allows communication between the first adsorption chamber 31 and the second adsorption chamber 32. The communicating part 34 is arranged so as to cover an opening of the first adsorption chamber 31 at the second end 31b and an opening of the second adsorption chamber 32 at the second end 32b.

In the canister 1, the first adsorption chamber 31, the communicating part 34, the second adsorption chamber 32, and the third adsorption chamber 33 form a flow path for the evaporated fuel having a substantially U-shape. The evaporated fuel taken in through the charge port 2A is adsorbed on the first adsorbent 4A in the first adsorption chamber 31. An evaporated fuel remaining non-adsorbed in the first adsorption chamber 31 passes through the communicating path 341, flows into the second adsorption chamber 32, and is then adsorbed on the second adsorbent 4B in the second adsorption chamber 32. Furthermore, an evaporated fuel remaining non-adsorbed in the second adsorption chamber 32 flows into the third adsorption chamber 33, and is then adsorbed on the third adsorbent 4C in the third adsorption chamber 33. The gas removed of the evaporated fuel is discharged from the atmosphere port 2C.

By supplying air from the atmosphere port 2C, the evaporated fuel adsorbed in each of the first adsorption chamber 31, the second adsorption chamber 32, and the third adsorption chamber 33 is discharged from the purge port 2B to the engine of the vehicle. As a result, the air containing the evaporated fuel is supplied to the engine.

### 1-2. Method of Manufacturing Canister

Descriptions are given to a method of manufacturing the canister 1 with reference to FIGS. 1 to 3. The method of manufacturing the canister 1 comprises at least a molding process and an arrangement process.

### <Molding Process>

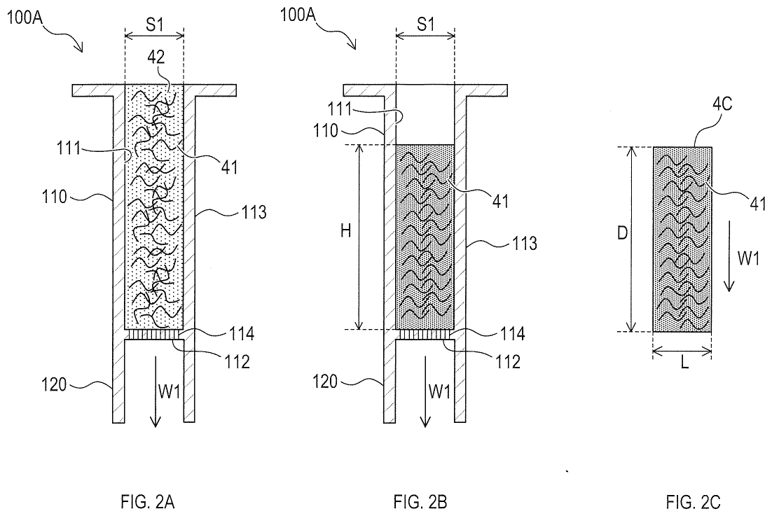

The molding process is a process to press fibrous activated carbons 41 in a specific direction, or perform suction to thereby gather the fibrous activated carbons 41 in a specific direction and mold the fibrous activated carbons 41 into the third adsorbent 4C. As illustrated in FIGS. 2A to 2C, the molding process in the present embodiment is a process to perform the suction to thereby gather the fibrous activated carbons 41 in the specific direction and mold the fibrous activated carbons 41 into the third adsorbent 4C. Hereinafter, a direction to gather the fibrous activated carbons 41 due to the suction is referred to as “suction direction W1”.

The molding process in the present embodiment utilizes a molding device 100A. The molding device 100A comprises a molding die 110 and a suction part 120.

The molding die 110 is a die including a molding surface configured to mold the fibrous activated carbons 41 into the third adsorbent 4C. The molding die 110 is made of metal, for example. The molding die 110 includes a recess 111 that corresponds to a contour of the third adsorbent 4C. The molding die 110 includes a bottom wall 112 forming a bottom surface of the recess 111 and a side wall 113 forming a side surface of the recess 111. The bottom surface and the side surface of the recess 111 correspond to the molding surface.

The bottom wall 112 has a contour in the form of, for example, a quadrangle flat plate in a plane view. The bottom wall 112 includes two or more through holes 114. The bottom wall 112 is in the form of a mesh, for example.

The side wall 113 extends from an entirety of a circumferential part on one side of the bottom wall 112. A distance S1 between two opposing parts in an inner surface of the side wall 113 (that is, the side surface of the recess 111) is set so as to correspond to the length L of the third adsorbent 4C.

The suction part 120 is configured to perform suction inside the recess 111 through the two or more through holes 114. In other words, the suction part 120 is configured to perform suction inside the recess 111 towards the bottom wall 112.

As illustrated in FIG. 2A, the molding process includes filling a dispersion liquid 42 containing the fibrous activated carbons 41 dispersed therein into the recess 111 of the molding die 110. The dispersion liquid 42 may contain, for example, a binder or a granular activated carbon in addition to the fibrous activated carbons 41.

Suction of the dispersion liquid 42 filled in the recess 111 is performed with the suction part 120 towards the bottom wall 112, to thereby remove moisture of the dispersion liquid 42 and gather the fibrous activated carbons 41 towards the bottom wall 112. Specifically, as illustrated in FIG. 2B, the dispersion liquid 42 is removed of the moisture, and the fibrous activated carbons 41 are gathered due to the suction towards the bottom wall 112 until a height of the fibrous activated carbons 41 inside the recess 111 from the bottom wall 112 is lowered to a specific height H. The specific height H is set so as to correspond to the equivalent diameter D of the third adsorbent 4C.

As a result of the dispersion liquid 42 being removed of moisture and the fibrous activated carbons 41 being gathered due to the suction of the dispersion liquid 42 filled in the molding die 110 as described above, the fibrous activated carbons 41 are molded into a columnar shape. The fibrous activated carbons 41 are molded into, for example, a quadrangular prism. As a result of the fibrous activated carbons 41 being molded into the columnar shape, the third adsorbent 4C can be obtained as illustrated in FIG. 2C. In the course of gathering the fibrous activated carbons 41 due to the suction, a fiber direction of the fibrous activated carbons 41 contained in the dispersion liquid 42 tends to be perpendicular to the suction direction W1, as illustrated in FIG. 2B. Therefore, as illustrated in FIG. 2C, the third adsorbent 4C molded in the molding process tends to contain plenty of the fibrous activated carbons 41 directed perpendicularly to the suction direction W1.

### <Arrangement Process>

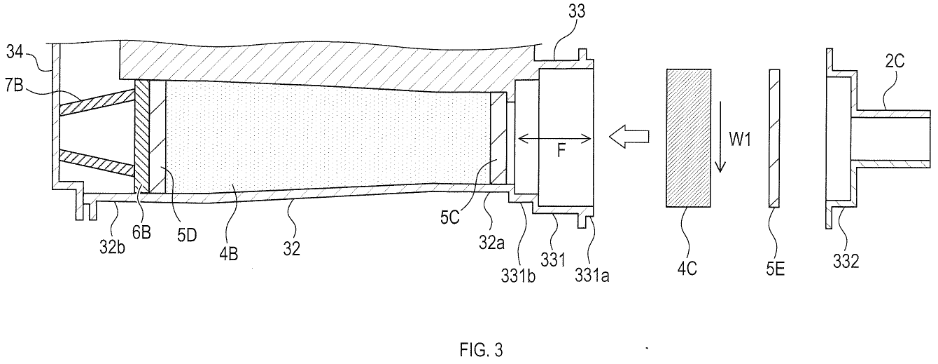

As illustrated in FIG. 3, the arrangement process is a process to arrange the third adsorbent 4C molded in the molding process inside the third adsorption chamber 33. The third adsorbent 4C molded in the molding process is press-fitted into the cylindrical part 331 through the opening at the first end 331a of the cylindrical part 331. The third adsorbent 4C is arranged inside the cylindrical part 331 such that the suction direction W1 in the third adsorbent 4C is perpendicular to flow directions F of the evaporated fuel. The flow directions F of the evaporated fuel herein are, more specifically, the flow directions F of the evaporated fuel in the third adsorption chamber 33.

Subsequently, the fifth filter 5E is press-fitted inside the cylindrical part 331 through the opening at the first end 331a of the cylindrical part 331.

Then, the lid 332 is arranged so as to cover the opening at the first end 331a of the cylindrical part 331. The lid 332 is joined to the cylindrical part 331 by, for example, vibration welding.

The arrangement process places the third adsorbent 4C in a state of being arranged inside the third adsorption chamber 33 as illustrated in FIG. 1.

### <Other Processes>

The first adsorbent 4A, the first filter 5A, the second filter 5B, and the first grid 6A are arranged inside the first adsorption chamber 31. The second adsorbent 4B, the third filter 5C, the fourth filter 5D, and the second grid 6B are arranged inside the second adsorption chamber 32. The communicating part 34 is arranged such that the first spring 7A is arranged so as to press the first adsorbent 4A; and the second spring 7B is arranged so as to press the second adsorbent 4B. Specifically, the communicating part 34 is arranged so as to cover the opening at the second end 31b of the first adsorption chamber 31 and the opening at the second end 32b of the second adsorption chamber 32.

These processes above produce the canister 1.

### 1-3. Effects

The first embodiment detailed above can bring effects to be described below.

(1a) The method of manufacturing the canister 1 comprises the molding process and the arrangement process. In the molding process, the third adsorbent 4C is molded by gathering the fibrous activated carbons 41 in the specific direction due to the suction. In the arrangement process, the third adsorbent 4C is arranged inside the third adsorption chamber 33 such that the suction direction W1 in the third adsorbent 4C is perpendicular to the flow directions F of the evaporated fuel.

In the above-described configuration, the molding process can mold the third adsorbent 4C containing plenty of the fibrous activated carbons 41 that are directed perpendicularly to the suction direction W1. In the arrangement process, the third adsorbent 4C molded in the molding process is arranged inside the third adsorption chamber 33 as described above. These processes can reduce the fibrous activated carbons 41 directed perpendicularly to the flow directions F of the evaporated fuel in the third adsorbent 4C arranged inside the third adsorption chamber 33. Therefore, ventilation resistance in the third adsorbent 4C can be reduced. As a result, pressure loss in the canister 1 can be reduced.

(1b) In the molding process, the dispersion liquid 42 containing the fibrous activated carbons 41 dispersed therein is filled in the recess 111 of the molding die 110, and the fibrous activated carbons 41 are gathered towards the bottom wall 112 due to the suction. Consequently, the third adsorbent 4C is molded. Such a configuration allows a relatively simple apparatus to mold the third adsorbent 4C containing plenty of the fibrous activated carbons 41 that are directed perpendicularly to the suction direction W1. Accordingly, the relatively simple apparatus can realize the canister 1 exhibiting reduced pressure loss.

(1c) In the case of molding an adsorbent having the length L shorter than the equivalent diameter D as in the third adsorbent 4C according to the present embodiment, in general, fibrous activated carbons are gathered due to suction in a direction corresponding to a lengthwise direction of the length L that is relatively small in dimension in the adsorbent. When the adsorbent molded in this way is arranged inside an adsorption chamber, a suction direction in the adsorbent is parallel to flow directions of an evaporated fuel in the adsorption chamber. That is, the adsorbent arranged inside the adsorption chamber tends to contain plenty of fibrous activated carbons directed perpendicularly to the flow directions of the evaporated fuel. In a case where the adsorbent contains plenty of the fibrous activated carbons directed perpendicularly to the flow directions of the evaporated fuel, ventilation resistance in the adsorbent increases.

In contrast, in the method of manufacturing the canister 1 according to the present embodiment, although the third adsorbent 4C has the equivalent diameter D greater than the length L, the fibrous activated carbons 41 are molded into the third adsorbent 4C in the molding process by being gathered due to the suction in a direction corresponding to a direction along the equivalent diameter D in the third adsorbent 4C. The third adsorbent 4C molded in the molding process is arranged in the arrangement process inside the third adsorption chamber 33 such that the suction direction W1 in the third adsorbent 4C is perpendicular to the flow directions F of the evaporated fuel. Such a configuration can achieve the canister 1 that includes the third adsorbent 4C having the equivalent diameter D greater than the length L, and exhibits reduced pressure loss.

(1d) As disclosed in WO 2023/054088A1, in a case where an adsorbent is formed by stacking two or more activated carbon moldings in the form of plates, arranging the adsorbent inside an adsorption chamber generally involves fixing the two or more activated carbon moldings one another with a fixing tool in order to avoid separation of the same.

In contrast, the third adsorbent 4C is molded into the activated carbon molding having a columnar shape. The third adsorbent 4C is arranged inside the third adsorption chamber 33 without utilizing the fixing tool. In the canister 1, which is the final product, the outer circumferential surface of the third adsorbent 4C about the flow directions of the evaporated fuel contacts the inner surface of the third adsorption chamber 33.

The above-described configuration can reduce the number of processes and the number of components involved in manufacturing the canister 1. Consequently, manufacturing cost of the canister 1 can be reduced.

### 2. Second Embodiment

### 2-1. Method of Manufacturing Canister

In a second embodiment, a method of manufacturing the canister 1 comprises at least a molding process and an arrangement process as in the first embodiment. The same reference numerals as those in the first embodiment indicate the same configurations, and reference is made to the preceding descriptions.

### <Molding Process>

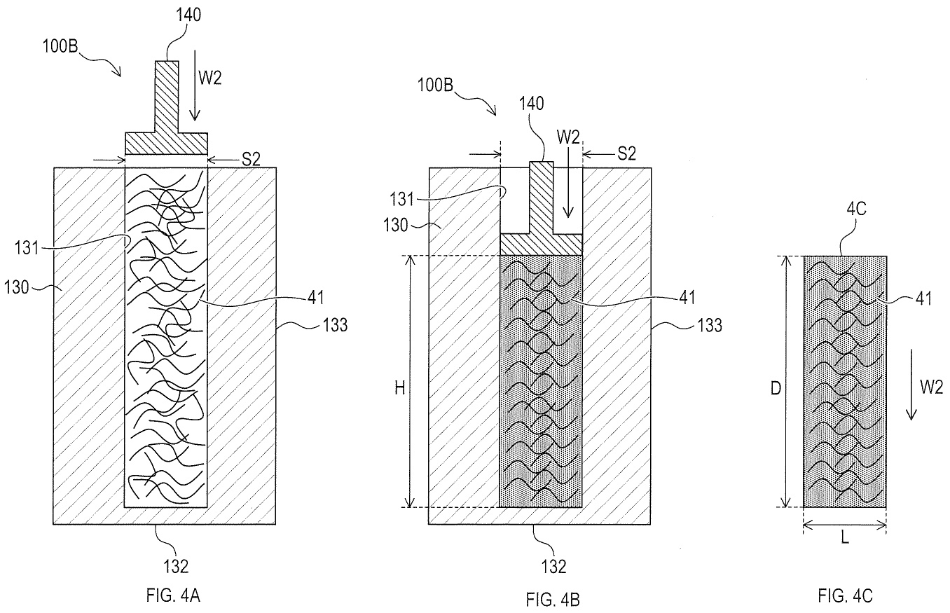

The molding process in the first embodiment is a process to gather the fibrous activated carbons 41 in the specific direction due to the suction to thereby mold the third adsorbent 4C. In contrast, as illustrated in FIGS. 4A to 4C, the molding process in the second embodiment is a process to press the fibrous activated carbons 41 in a specific direction to thereby mold the third adsorbent 4C. Hereinafter, a direction to press the fibrous activated carbons 41 in the second embodiment is referred to as “pressing direction W2”.

The molding process in the second embodiment utilizes a molding device 100B. The molding device 100B comprises a molding die 130 and a pressing part 140.

The molding die 130 is a die including a molding surface configured to mold the fibrous activated carbons 41 into the third adsorbent 4C. The molding die 130 is made of metal, for example. The molding die 130 includes a recess 131 corresponding to the contour of the third adsorbent 4C. The molding die 130 includes a bottom wall 132 forming a bottom surface of the recess 131 and a side wall 133 forming a side surface of the recess 131. The bottom surface and the side surface of the recess 131 correspond to the molding surface.

The bottom wall 132 has a contour in the form of, for example, a quadrangle flat plate in a plane view.

The side wall 133 extends from an entirety of a circumferential part on one side of the bottom wall 132. A distance S2 between two opposing parts in an inner surface of the side wall 133 (that is, the side surface of the recess 131) is set so as to correspond to the length L of the third adsorbent 4C.

The pressing part 140 is configured to be slidable inside the recess 131. The pressing part 140 is configured to perform pressing inside the recess 131. A pressing surface of the pressing part 140 is the molding surface. The pressing surface of the pressing part 140 is a part of an outer surface of the pressing part 140 facing the bottom wall 132 when the pressing is performed inside the recess 131. The pressing surface may be flat, for example.

As illustrated in FIG. 4A, in the molding process, the fibrous activated carbons 41 are filled in the recess 131 of the molding die 130. The fibrous activated carbons 41 filled in the recess 131 is pressed towards the bottom wall 132 with the pressing part 140. Specifically, as illustrated in FIG. 4B, the fibrous activated carbons 41 are pressed towards the bottom wall 132 until a height of the fibrous activated carbons 41 inside the recess 131 from the bottom wall 132 is reduced to a specific height H. The specific height H is the same as the specific height H in the first embodiment.

The fibrous activated carbons 41 are molded into a columnar shape by being pressed as described above. The fibrous activated carbons 41 are molded into, for example, a quadrangular prism. As a result of the fibrous activated carbons 41 being molded into a columnar shape, the third adsorbent 4C can be obtained as illustrated in FIG. 4C. In the course of pressing the fibrous activated carbons 41, a fiber direction of the fibrous activated carbons 41 tends to be perpendicular to the pressing direction W2 as illustrated in FIG. 2B. Therefore, as illustrated in FIG. 4C, the third adsorbent 4C molded in the molding process tends to contain plenty of the fibrous activated carbons 41 directed perpendicularly to the pressing direction W2.

### <Arrangement Process>

The arrangement process in the second embodiment is the same as the arrangement process in the first embodiment. It should be noted that, in the second embodiment, the suction direction W1 in the first embodiment is replaced with the pressing direction W2.

### 2-2. Effects

As described below, the second embodiment detailed above can bring the same effects as the above-described effects (1a) and (1b). Moreover, the same effects as the above-described effects (1c) and (1d) can be obtained. It should be noted that the suction and the suction direction W1 described in (1c) above are replaced with the pressing and the pressing direction W2, respectively.

(2a) The method of manufacturing the canister 1 in the second embodiment comprises the molding process and the arrangement process as in the first embodiment. Such a configuration can mold the third adsorbent 4C that contains plenty of the fibrous activated carbons 41 directed perpendicularly to the pressing direction W2 by pressing the fibrous activated carbons 41 in the specific direction in the molding process. In the arrangement process, the third adsorbent 4C is arranged inside the third adsorption chamber 33 such that the pressing direction W2 in the third adsorbent 4C is perpendicular to the flow directions F of the evaporated fuel. In this way, the fibrous activated carbons 41 directed perpendicularly to the flow directions F of the evaporated fuel can be reduced in the third adsorbent 4C arranged inside the third adsorption chamber 33. Accordingly, the same effect as the effect (1a) above can be obtained.

(2b) In the molding process, the fibrous activated carbons 41 are filled in the recess 131 of the molding die 130 and pressed towards the bottom wall 132. Consequently, the third adsorbent 4C is molded. Such a configuration enables a relatively simple apparatus to mold the third adsorbent 4C containing plenty of the fibrous activated carbons 41 directed perpendicularly to the pressing direction W2.

Accordingly, the same effect as the effect (1b) above can be obtained.

### 3. Third Embodiment

### 3-1. Method of Manufacturing Canister

In a third embodiment, a method of manufacturing the canister 1 comprises at least a molding process and an arrangement process as in the first and second embodiments. The same reference numerals as those in the first and second embodiments indicate the same configurations, and a reference is made to the preceding descriptions.

### <Molding Process>

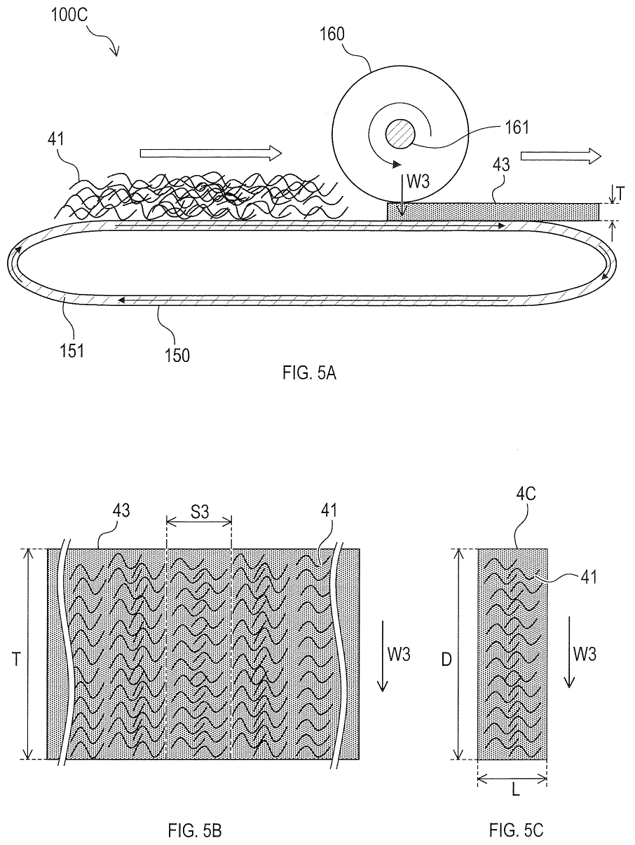

As illustrated in FIGS. 5A to 5C, the molding process in the third embodiment is a process to press the fibrous activated carbons 41 in a specific direction to thereby mold the third adsorbent 4C as in the molding process in the second embodiment. Hereinafter, a direction to press the fibrous activated carbons 41 in the third embodiment is referred to as “pressing direction W3”. The molding process in the third embodiment includes a molding work and a cutting work.

### (Molding Work)

The molding work utilizes a molding device 100C illustrated in FIG. 5A. The molding device 100C includes a conveyor 150 and a roller 160. The conveyor 150 includes a belt 151 that can circulate. The conveyor 150 is configured to convey the fibrous activated carbons 41 deposited on the belt 151 to the roller 160 by utilizing circulation of the belt 151.

The roller 160 is arranged above the belt 151. The roller 160 is configured to be rotatable about a rotation shaft 161. The roller 160 is configured to press the fibrous activated carbons 41 deposited on the belt 151 towards the belt 151.

In the molding work, as illustrated in FIG. 5A, the fibrous activated carbons 41 are deposited on an upper surface of the belt 151. The circulation of the belt 151 causes the fibrous activated carbons 41 to be conveyed towards the roller 160, where the fibrous activated carbons 41 are pressed towards the belt 151 with the roller 160. This produces a semi-finished molding 43 in the form of a sheet. The semi-finished molding 43 has a thickness T identical to the equivalent diameter D of the third adsorbent 4C. Specifically, in the molding device 100C, the roller 160 is arranged so as to have, between itself and the upper surface of the belt 151, a space that corresponds to the equivalent diameter D of the third adsorbent 4C.

In the course of pressing the fibrous activated carbons 41, a fiber direction of the fibrous activated carbons 41 tends to be perpendicular to the pressing direction W3 as illustrated in FIG. 5B. Therefore, the semi-finished molding 43 produced in the molding work tends to contain plenty of the fibrous activated carbons 41 directed perpendicularly to the pressing direction W3.

### (Cutting Work)

In the cutting work, the semi-finished molding 43 produced in the molding work is cut to a size S3 that corresponds to the length L of the third adsorbent 4C to thereby be formed into a columnar shape. FIG. 5B indicates one example of a cutting line in two-dot line. Due to the semi-finished molding 43 being formed into the columnar shape, the third adsorbent 4C can be obtained as illustrated in FIG. 5C. The third adsorbent 4C molded through the molding work and the cutting work tends to contain plenty of the fibrous activated carbons 41 directed perpendicularly to the pressing direction W3.

### <Arrangement Process>

The arrangement process in the third embodiment is the same as the arrangement process in the first embodiment. It should be noted that the suction direction W1 in the first embodiment is replaced with the pressing direction W3 in the third embodiment.

### 3-2. Effects

For the same reason stated in (2a) above, the third embodiment detailed above can bring the same effect as the effect (1a) above. Moreover, the same effects as the effects (1c) and (1d) above can be obtained. It should be noted that the suction and the suction direction W1 described in (1c) above are replaced with the pressing and the pressing direction W3, respectively.

### 4. Other Embodiments

Although embodiments of the present disclosure have been described hereinabove, the present disclosure is not limited to the above-described embodiments and can take various forms.

(4a) In the above-described embodiments, the third adsorbent 4C has the equivalent diameter D greater than the length L. However, the equivalent diameter D may not necessarily be greater than the length L. For example, the third adsorbent 4C may have the equivalent diameter D that is the same as the length L.

(4b) In the above-described embodiments, the atmosphere port 2C is directly connected to the third adsorption chamber 33. However, the third adsorption chamber 33 may be coupled to the atmosphere port 2C via another chamber, for example. That is, there may be provided another chamber between the third adsorption chamber 33 and the atmosphere port 2C.

(4c) In the above-described embodiments, a single function performed by a single element may be distributed to two or more elements, and a single function performed by two or more elements may be integrated into one element. A part of the configuration in the above-described embodiments may be omitted. At least a part of the configuration in the above-described embodiments may be added to or replaced with another configuration of the above-described embodiments.

What is claimed is:

1. A method of manufacturing a canister including an activated carbon molding configured to adsorb an evaporated fuel originating in a fuel tank of a vehicle; and an adsorption chamber accommodating the activated carbon molding, the method comprising:
pressing fibrous activated carbons in a specific direction, or performing suction to thereby gather the fibrous activated carbons in the specific direction and mold the fibrous activated carbons into the activated carbon molding that has a columnar shape; and
arranging, inside the adsorption chamber, the activated carbon molding produced such that a pressing direction or a suction direction in the activated carbon molding is perpendicular to a flow direction of the evaporated fuel.

2. The method according to claim 1, wherein the activated carbon molding is produced by filling a dispersion liquid containing the fibrous activated carbons dispersed therein into a molding die whose bottom wall is provided with two or more through holes, and gathering the fibrous activated carbons towards the bottom wall due to the suction.

3. The method according to claim 1, wherein, in a cross-section perpendicular to the flow direction of the evaporated fuel, the activated carbon molding arranged inside the adsorption chamber has an equivalent diameter greater than a length of the activated carbon molding along the flow direction of the evaporated fuel.

4. The method according to claim 1, wherein an outer circumferential surface, about the flow direction of the evaporated fuel, of the activated carbon molding arranged inside the adsorption chamber contacts an inner surface of the adsorption chamber.

5. The method according to claim 1, wherein the adsorption chamber is connected to an atmosphere port open to atmosphere.
